(19) United States
(12) Patent Application Publication
(10) Pub. No.: US 2011/0025036 A1
(43) Pub. Date: Feb. 3, 2011

(54) Self-adhesive covering paper

(76) Inventor: Bulent Yener, Istanbul (TR)

Correspondence Address: Oppedahl Patent Law Firm LLC, P O Box 5940, Dillon, CO, 80435-5940, US

(21) Appl. No.: 12/936,170

(22) PCT Filed: Mar. 12, 2009
(86) PCT No.: PCT/TR09/00038

§ 371 Date: Oct. 4, 2010

(30) Foreign Application Priority Data
Apr. 4, 2008 (TR) 2008 02298

(51) Int. Cl. B42D 3/00

(52) U.S. Cl. 281/29

(57) ABSTRACT

Our invention is a self-adhesive covering paper providing the notebooks or the books in different sizes to be covered practically and fast in a way not Io leave any space between or not to cause any bending, and which is produced from paper which is patterned or in a single colour.

Our invention is a self-adhesive covering paper providing the notebooks or books in various sizes to be covered practically and fast in a way that there will be no space left between and no bending will occur, by means of being produced in different sizes, and which is produced of paper which is patterned or in a single colour.

The most known and common covering products used currently for covering notebook or book are the covering papers produced of nylon. For being able to cover notebook or book by means of using this product, primarily, the nylon cover page is cut by scaling in a way appropriate for the notebook or book to be covered and then placed under the notebook or the book to be covered. After this process, the notebook or the book is covered by means of using a covering method that is quite difficult and that requires effort by the help of the adhesive bands. Requiring a lot of effort and time of being able to make covering implementations by these mentioned covering products is the biggest disadvantage that the method and the product have.

Another covering product used in the known art are the covering papers the whole bottom surface of which are covered with an adhesive substance like the wall papers. For being able to make covering by these papers; the scale of the paper should be taken according to the notebook or the book to be covered as in the first method we have mentioned above. Then the covering paper is covered on the exterior surface of the notebook or the book by means of taking the protector band protecting the adhesive surface from the paper cut as scaled. However, the most important problem in the implementations done by this product is that the paper does not fit well on the book or notebook in the littlest false positioning as a result of the bottom surface of the covering paper being completely covered with adhesive material, and its being very difficult to rip and straighten as a result of the adhesive material being very strong.

Another type of the covering paper used currently covering papers which are generally produced of caoutchouc or solid plastic material, produced as scaled according to the sizes of the standard notebooks or the books, and which we can describe as interlaced type. At the inner parts of both ends of these products, there are pockets formed by means of curling inwards. The covering process can be completed in a short time and practically by means of interlacing the front and back covers of the book or the notebook to be covered into these two pockets. However, the most important problem in this implementation is that the size discrepancies cannot be prevented as a result of the thickness differences of the books or the notebooks. Therefore, if the thickness of the notebook or the book is much, bending may occur at the covers of the notebook or the book as the sizes of the covering paper is left small. If the book or the notebook to be covered is very thin, in this case spaces occur at the covering paper and the book or the notebook moves in the covering paper. For minimizing this disadvantage, the producer firms are required to produce different covering papers at very various sizes. This case increases the production costs, thus the retail sale price where the product reaches the final user.

In the self-adhesive covering paper which is our invention and which provides making practical and fast covering, practical and fast covering can be done by the help of the interlaced pocket which we use at single side of the product and the adhesive part which we use at the other side. After one cover of the book or notebook is interlaced into the pocket at the single side, the covering process is completed by adhering the adhesive lug at the other cover side after the covering paper is arranged in appropriate sizes according to the thickness of the notebook or the book after it is bent and after the band protecting the adhesive surface is taken off.

The covering process can be completed practically and fast without leaving any space between the covering paper and the book or the notebook to be covered or without causing bending due to the scale difference by the help of our product the subject of the invention and the covering method where the product is used.

Our invention can also meet the decorative features which are the secondary objectives apart from the protecting objective of the covering papers in the best way as it can be produced both as patterned or pictorial and in single colours in addition to these advantages.

The figures and the related descriptions required for the Self-Adhesive Covering Paper Providing Practical and Fast Covering to be better understood are as follows:

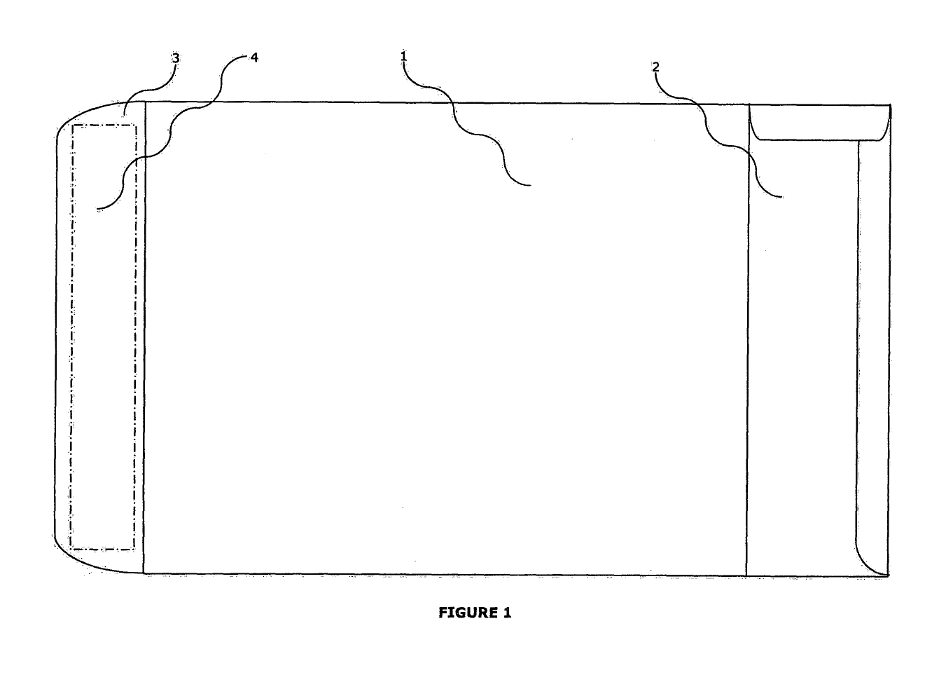

FIG. 1 is the general view of the Self-Adhesive Covering Paper Providing Practical and Fast Covering subject of the invention in the open position

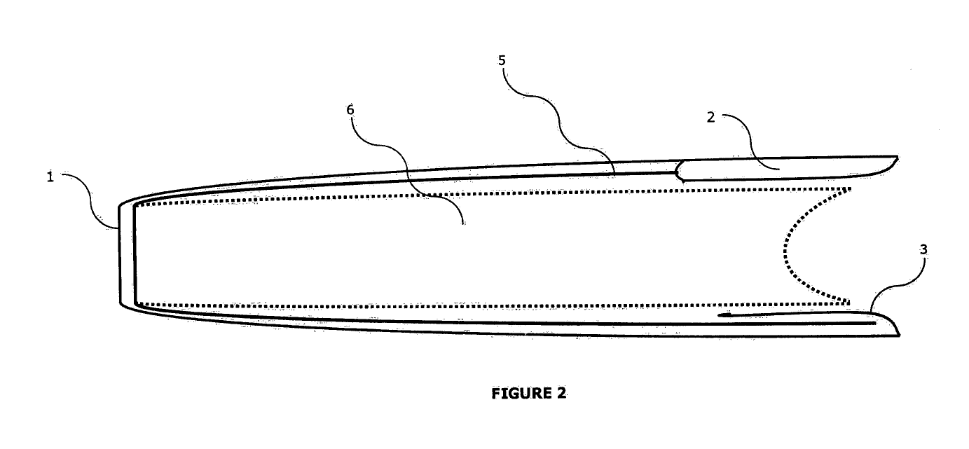

FIG. 2 is the general side view of the Self-Adhesive Covering Paper Providing Practical and Fast Covering subject of the invention covered on a notebook or a book

The parts on the figures helping the invention to be understood better are enumerated; the short definitions of the numbers are given below:
1. Covering paper
2. Pocket part
3. Adhesive lug
4. Protector band
5. Notebook or book cover
6. Notebook or book

After one cover (5) of the notebook (6) or the book to be covered is interlaced into the pocket part (2) of our invention, the covering paper (1) is scaled by being arranged according to the sizes of the notebook (6) or the book by means of opening the notebook (6) or the book covers (5) completely. Then the sizes of the both products are equalized in a way not to cause any space or bending between by means of closing the notebook (6) or the book to be covered by holding together with the covering paper (1). After the required arrangement is made, the adhesive lug (3) is folded inwards of the other cover (5) of the notebook (5) or the book to be covered and adhered to the cover (5) by taking the protector band (4) present at the adhesive lug (3) off. Therefore, the covering process is completed fast and in a practical way without leaving any space between or causing any bending.

1. Our invention is a self-adhesive covering paper (1) providing practical and fast covering; intended to provide notebook (6) and the books in different sizes to be covered practically and fast in a way there will be no space left between and no bending will occur by being able to be produced from the paper which is patterned or in a single colour.

2. A self-adhesive covering paper (1) providing practical and fast covering mentioned in claim 1; intended to have a pocket part (2) where one cover (5) of the notebook (6) or the book to be covered is interlaced.

3. A self-adhesive covering paper (1) providing practical and fast covering mentioned in claim 1; intended to have an adhesive lug (3) which enables the space between the notebook (6) or the book and the covering paper (1) to be taken and the sizes of the two products to be equalized, and which provides the covering paper to be fixed by means of being adhered at the inner part of one cover (5) of the notebook (6) or the book to be covered.

4. A self-adhesive covering paper (1) providing practical and fast covering mentioned in claim 1; intended to have a protector band (4) protecting the adhesive for preventing the adhesive part present on the adhesive lug (3) from being adhered onto different places in an unwanted way during the covering process.
